(19) United States
(12) Patent Application Publication
(10) Pub. No.: US 2006/0121624 A1
(43) Pub. Date: Jun. 8, 2006

(54) Methods and systems for fluid delivery

(76) Inventors: Lotien Richard Huang, Brookline, MA (US); Maury D. Cosman, Medfield, MA (US); Bruce L. Carvalho, Watertown, MA (US); Paul Vernucci, (US); Ravi Kapur, Boston, MA (US)

Correspondence Address: CLARK & ELBING LLP, 101 FEDERAL STREET, BOSTON, MA, 02110, US

(21) Appl. No.: 11/227,469

(22) Filed: Sep. 15, 2005

Related U.S. Application Data
(63) Continuation-in-part of application No. 11/071,270, filed on Mar. 3, 2005.
(60) Provisional application No. 60/549,680, filed on Mar. 3, 2004.

(51) Int. Cl. B01L 3/00

(52) U.S. Cl. 436/180; 422/100

(57) ABSTRACT

The systems and methods herein involve the use of an automated, high-throughput system that utilizes pressure to transfer a fluid medium containing an analyte. In preferred embodiments, the sample is delivered to an analytical device. The sample can comprise one or more analytes, e.g., solvents, solutes, or particles, including rare cells. The systems are designed to minimize contact with potentially hazardous, fragile, or valuable samples. The systems allow for the dilution, mixing, and introduction of the fluid medium to an analytical device, followed by possible further analysis or sample manipulation. The systems and methods herein allow for partial or substantially complete depletion of a sample container to avoid wasting rare analytes or prevent retention of desired material in a first container.

### CROSS-REFERENCE TO RELATED APPLICATIONS

This application is a continuation-in-part of U.S. patent application Ser. No. 11/071,270, filed Mar. 3, 2005, which claims benefit of U.S. Provisional Application No. 60/549,680, filed Mar. 3, 2004, each of which is hereby incorporated by reference.

### BACKGROUND OF THE INVENTION

The invention relates to the field of sample delivery and microfluidics.

Blood samples are routinely drawn for diagnostic purposes in standardized glass collection tubes containing anticoagulants such as EDTA, citrate, or heparin. The Vacutainer brand (e.g., from Becton Dickinson) of tubes facilitates drawing of patient blood samples by virtue of a partial vacuum in the tube, which is retained during storage of the tubes by a silicone rubber stopper/septum. It is, however, difficult to transfer blood and blood cells from such containers to analytical devices in an automated way. For example, blood cells may sediment potentially leading to inaccurate blood counts. In addition, the transfer of blood and subsequent mixing with reagents or diluents may lead to cell loss, sample contamination from the environment, or risk of infection to personnel.

Thus, there is a need for improved methods of transfer of blood from storage containers to analytical devices.

### SUMMARY OF THE INVENTION

The invention features methods and devices for the delivery of a fluid medium, e.g., a liquid, containing one or more analytes, e.g., particles, solutes, or solvents, to one or more analytical devices. Furthermore, the system features methods for delivering two or more fluid media to an analytical device. The systems are designed to minimize contact with or loss of potentially hazardous, fragile, or valuable samples. The systems allow for the dilution, labeling, preserving, mixing, and introduction of the fluid medium or media to one or more analytical devices, followed by possible further analysis or sample manipulation. The systems provide an automated, flow-rate regulated and substantially complete delivery of a sample and one or more additional fluid media to one or more analytical devices.

In one aspect, the invention features a method for delivering an analyte to an analytical device including the steps of providing a sample container having an outlet and containing a fluid medium including the analyte; the analytical device; and a connector, e.g., a transfer line, fluidically connecting the outlet and the analytical device; and pumping or removing at least a portion of the fluid medium through the outlet and the connector into the analytical device, during which the fluid medium in the sample container is optionally agitated to partially or substantially maintain homogeneity of the fluid sample. The connector may include a diluent inlet through which diluent can be introduced in order to dilute the sample prior to introduction into the analytical device. The connector or the analytical device may further include a mixer capable of mixing the fluid medium and the diluent.

The invention also features an alternative method for delivering an analyte to an analytical device including providing a sample container having an outlet and containing a fluid medium including the analyte; the analytical device; a fluidic switch; and a diluent reservoir containing diluent, wherein the outlet is fluidically connected to the analytical device, and the fluidic switch is fluidically connected to the analytical device and the diluent reservoir; pumping the diluent through the fluidic switch and the analytical device into the sample container to, for example, dilute the sample, wherein the fluidic switch directs the diluent into the analytical device; and pumping at least a portion of the mixed sample (e.g., diluted sample) through the outlet and into the analytical device, during which the mixed sample in the sample container is optionally agitated. In this method, the mixed sample may be pumped through the analytical device, e.g., in its entirety. The fluidic switch may prevent the mixed sample from entering the diluent reservoir, e.g., by directing the sample that has passed through the analytical device to a waster container.

Another method of the invention for delivering an analyte to an analytical device includes providing a sample container having an outlet and containing a fluid medium including the analyte; the analytical device; and a diluent reservoir containing diluent, wherein the outlet is fluidically connected to the analytical device, and the analytical device is fluidically connected to the diluent reservoir; pumping diluent from the diluent reservoir through the analytical device and the outlet into the sample container to cause the fluid in the reservoir and the sample to mix (e.g., to dilute the sample); and pumping at least a portion of the mixed sample (e.g., diluted sample) from the sample container through the outlet into the analytical device, during which the mixed sample in the sample container may be agitated to partially or substantially maintain homogeneity of the sample.

An additional method of the invention for delivering an analyte to an analytical device includes providing a sample container having an outlet and containing a fluid medium comprising the analyte (e.g., rare cells); a diluent reservoir containing diluent; and the analytical device, wherein the outlet is fluidically connected to the diluent reservoir, and the diluent reservoir is fluidically connected to the analytical device; pumping at least a portion of the fluid medium from the sample container through the outlet into the diluent reservoir to mix the fluid sample with the diluent (e.g., to dilute the sample), during which the fluid medium in the sample container may be agitated to partially or substantially maintain homogeneity; and pumping at least a portion of the mixed sample (e.g., diluted sample) from the diluent reservoir into the analytical device, during which the diluent reservoir may be agitated to partially or substantially maintain homogeneity in the mixed sample.

The invention further features a method for delivering a sample, e.g., blood, to an analytical device including providing a sample container including the sample and a plug, as described herein, and introducing a pressurizing fluid through the second port, thereby forcing the sample out of the first port. The method may further include continuously rocking the sample container. The method may further include inverting the sample container prior to introducing the pressurizing fluid.

An additional method of the invention for delivering an analyte to an analytical device includes providing a sample container that includes a first inlet, a first outlet coupled to the analytical device, and a first fluid medium, e.g. a liquid medium, including the analyte; a chamber capable of being pressurized; and the analytical device; disposing the first inlet in the chamber; and pumping a pressurizing fluid immiscible with the first fluid medium into the chamber, thereby causing at least a portion of the first fluid medium to flow from the sample container through the first outlet into the analytical device. In this method, a diluent reservoir having a second inlet, a second outlet coupled to the analytical device, and a second fluid medium, e.g., a liquid medium, e.g., a diluent, may also be provided. The second inlet may be disposed in the same chamber as the first inlet or in a separate chamber capable of being pressurized, and the method may further include causing at least a portion of the second fluid medium to flow through the second outlet into the analytical device. The first fluid medium may be pumped through the analytical device.

The invention also features a system for combining two or more fluid media and delivering fluid media to one or more analytical devices. Such fluid media can reside initially in separate containers and can be maintained under separate conditions (e.g., temperature).

In another aspect, the invention features a delivery system including an analytical device; a connector, e.g., a transfer line, fluidically connected to the analytical device, wherein a sample container is capable of being fluidically connected to the connector; and an agitator, e.g., capable of substantially maintaining homogeneity in a fluid medium. As above, the connector comprises a diluent inlet through which diluent can be introduced. The connector may also include a mixer capable of mixing diluent and a fluid medium.

Another delivery system of the invention includes an analytical device capable of being fluidically connected to a sample container; a fluidic switch; a diluent reservoir; and an agitator, e.g., capable of substantially maintaining homogeneity in a fluid medium, wherein the fluidic switch is fluidically connected to the analytical device and the diluent reservoir, and wherein the fluidic switch is capable of preventing the flow of fluid between the analytical device and the diluent reservoir.

The invention also features a delivery system including an analytical device capable of being fluidically connected to a sample container; a diluent reservoir, wherein the analytical device is fluidically connected to the diluent reservoir; and an agitator capable of substantially maintaining homogeneity in a fluid medium.

An additional delivery system of the invention includes a diluent reservoir capable of being fluidically connected to a sample container; an analytical device fluidically connected to the diluent reservoir; and an agitator capable of substantially maintaining homogeneity in a fluid medium.

An additional delivery system of the invention includes an analytical device; a sample container that includes a first inlet and a first outlet, wherein the first outlet is coupled to the analytical device; and a chamber that is fluidically connected to the first inlet and capable of being pressurized. The chamber may be integrated into the device. Furthermore, the chamber may include a cap enclosing the sample container or a portion thereof, e.g., the inlet. The delivery system may further include an additional reservoir, e.g., diluent or sample, that includes a second inlet and a second outlet, wherein the second outlet is coupled to the analytical device. The second inlet may be fluidically connected to the same chamber as the first inlet, or it may be disposed in a separate chamber. Additional reservoirs may be added in a similar fashion. The delivery system may further include an agitator that agitates the sample container in order to partially or substantially maintain homogeneity. The analytical device is preferably capable of producing a sample enriched in a particular analyte, as described herein.

The invention further features a system including an analytical device fluidically coupled to a sample container having a plug that includes a first tube extending through the plug and ending within a fluid sample, and a second tube extending through the plug to a region above the fluid sample. The system additionally includes an agitator for the sample container. In this system, the agitator may be adapted to maintain a liquid sample within the sample container in a substantially homogeneous state. The system may also include a connector that connects the sample container to the analytical device; this connector may include an input coupled to the second tube of the sample container and a sample output coupled to the first tube of the analytical device. A pressurizing fluid, e.g., air, source may be coupled to the input. The connector may further include an inlet that allows the introduction of a second fluid, e.g., a diluent, into the analyzer. The second fluid may include, for example, an anti-coagulant, a wetting agent, a fixing agent, a preservative, or a fluorescent probe. The system may further include a mixer coupled to the connector to enhance mixing of the sample and the second fluid and/or a fluidic switch fluidically capable of preventing the flow of the second fluid to the analytical device.

In another aspect, the invention features a plug for a sample container. The plug has a top having a depression and a bottom, and, when inserted into a sample container, the top is in contact with the sample. A first port traverses the plug from the top to the bottom and is in fluidic connection with the depression, and a second port traverses the plug from the top to the bottom and is not in fluidic contact with the depression. The second port may be connected to a pressure source, and the first port may be connected to a connector, e.g., a transfer line, capable of being connected to an analytical device.

The invention further features a plug for a sample container. The plug includes the following elements: a top and a bottom, such that, when inserted into a sample container, the top, which includes a depression, is in contact with a sample; a first port traversing the plug from the top to the bottom and in fluidic connection with the depression; and a second port traversing the plug from the top to the bottom and not in fluidic contact with the depression. The first port may be an outlet and may or may not be centered in the middle of the depression. The second port may be an inlet for delivery of a pressurizing fluid, e.g., a gas, e.g., air, into the region of the sample container above the sample. The plug of the invention may be threaded to fit small compression fittings. The plug may further include a sealing material; alternatively, the plug may be made of an elastic material.

In any of the embodiments herein, more than one sample container may be fluidically connected to the systems disclosed. In addition, one or more diluent reservoirs may be fluidically connected to the analytical device and/or sample containers herein, and more than one analytical device may be coupled to the systems herein. For example, a labeling reservoir containing a labeling reagent may be fluidically connected to the analytical device. Each of the sample containers and reservoirs may contain multiple inlets or outlets and may be independently controlled, e.g., using the automated pressurizing system disclosed.

In various embodiments, the fluid medium in the sample container, or a diluent reservoir, is agitated to partially or substantially maintain homogeneity. The fluid media used in the methods and systems of the invention are preferably liquids. The agitation, e.g., used to reduce sedimentation of particles in the medium, occurs by applying mechanical or acoustical force or by circulating the medium. Agitation, by any means, and depending on the sample type, may occur at a rate of 1-1,000 Hz, and may occur through any angle known in the art, including 120-180°, 130-179°, 140-178°, 150-177°, 160-170°, any other angle less than or slightly less than 180°. Alternatively, agitation need not occur. The sample container may also have an inlet, which may or may not be in fluid contact with the fluid medium, and through which a pressurizing fluid may be introduced. Such an inlet may be coaxial with the outlet. Any container, e.g., for sample or diluent, that is pressurized in the methods of the invention may contain a pressure release valve. In some embodiments, pumping may occur by pressurizing the sample container using, e.g., pressurized fluid such as air. Pumping may occur, for example, by introducing a pressurizing fluid into a container to force at least a portion of the fluid out of the container. A syringe or other pumping means may be used. The rate of flow of the sample out of the sample container may be between 100 μl/hr and 100 ml/hr. Exemplary rates include 0.1-200 ml/hr, 1-150 ml/hr, 1-100 ml/hr, 10-100 ml/hr, 10-90 ml/hr, 20-80 ml/hr, 20-50 ml/hr, 30-70 ml/hr, and 40-60 ml/hr. Such rates may be constant or may fluctuate. In some instances, the flow rate is more than 1, 10, 50, 100, or 150 ml/hr. The analytical device is preferably capable of producing a sample enriched in a particular analyte, as described herein, e.g., by employing affinity mechanisms such as capture moieties capable of selectively binding a portion of the analyte; a size, shape, or deformability based separation medium; or a magnetic based separation medium.

Exemplary fluid media, e.g., samples or diluents, include or may contain a bodily fluid, buffer, diluting reagent, preservation reagent, priming reagent, washing reagent, osmolarity regulating reagent, fixing reagent, wetting reagent, labeling reagent, lysing reagent, immunomagnetic reagent, anti-coagulant, binding reagent, polynucleotide amplification reagent, drying reagent, cationic detergent, enzyme, reagents that specifically interact with or bind an analyte of interest (such as a rare cell), and substrates. Examples of bodily fluid include, but are not limited to, blood, sweat, tears, ear flow, sputum, lymph, bone marrow suspension, lymph, urine, saliva, semen, vaginal flow, cerebrospinal fluid, brain fluid, ascites, milk, secretions of the respiratory, intestinal and genitourinary tracts, and amniotic fluid. Moreover, any sample which is fluidic or capable of being incorporated into a fluid medium can be utilized in the disclosed system, e.g., a cell suspension. A fluid medium may be whole blood, or portion thereof, derived from an organism to be diagnosed with a condition such as a neoplastic condition, inflammation, pregnancy, trauma, ischemia, and endometriosis, or to be evaluated for a status, e.g., sex or age. In some preferred embodiments, a fluid medium is whole blood, or portion thereof, obtained from a pregnant mammal (such as a human) and is introduced, using the systems and methods herein, to an analytical device to diagnose a fetus of the pregnant mammal. Samples may be pre-diluted or otherwise manipulated prior to introduction of the sample to the sample container. For example, a sample may be mixed with a diluent in any ratio useful in the art, e.g., 100:1, 10:1, 4:1, 1:1, 1:4, 1:10, or 1:100. Alternatively, the first fluid medium (e.g., a liquid medium containing sample) and diluent are placed in initial contact within the analytical device. For example, a connector (e.g., a transfer line) may include a diluent inlet through which a diluent can be introduced. In another example, when the diluent is an immunomagnetic reagent, a connector, e.g., transfer line, may include an inlet through which a solution comprising immunomagnetic particles can be introduced in order to bind an analyte in the sample prior to introduction into an analytical device or within an analytical device. An analyte may contain rare cells or particles, which, in a biological context, include, depending on the sample, fetal cells, e.g. fetal nucleated red blood cells (fnRBCs), progenitor cells, stem cells (e.g., undifferentiated), foam cells, cancer cells, immune system cells (host or graft), epithelial cells, endothelial cells, connective tissue cells, bacteria, fungi, viruses, and pathogens (e.g., bacterial or protozoa).

A pressure-driven delivery system may be used to deliver multiple fluids into an analytical device, for example a microfluidic device. When the analyte is delivered to the analytical device, it may be analyzed, e.g., by contacting the analyte with a labeling moiety (for example, for PCR, RT-PCR, DNA sequencing, mass spectrometry, or in situ hybridization analysis of cells). A portion of the analyte may also be selectively retained in the analytical device, e.g., through binding to capture moieties; size, shape, or deformability based retention; or magnetic based retention. The analytical device may also be rinsed after the analyte is introduced therein. Portions of the analyte may also be enriched relative to others, e.g., through size, shape, or deformability based separation, such as filtration or deterministic separation; through magnetic based enrichment; or through selective lysis. Such enrichment may occur before, during, or after an analyte is delivered using the methods of the invention. In addition, additional diluents, e.g., containing reagents or rinses, may be introduced into the analytical device. The introduction of such additional diluents may be controlled by a fluidic switch.

The systems and plugs of the invention may be employed in the methods described herein. In addition, the wetting methods described herein may be used to enhance the introduction of fluid media in the methods and systems of the invention.

By “agitation” is meant any form of steering, moving, shaking, vibrating, bumping, rocking, or other action that causes movement of molecules or particles within a fluid.

By “analyte” is meant a molecule, other chemical species, e.g., an ion, or particle. Exemplary analytes include cells, viruses, nucleic acids, proteins, carbohydrates, and small organic molecules.

By “analytical device” is meant any device suitable for preparation, separation, modification, analysis, storage, or performing any other desirable activity on a sample.

By “capture moiety” is meant a chemical species to which an analyte binds. A capture moiety may be a compound coupled to a surface or the material making up the surface. Exemplary capture moieties include antibodies, oligo- or polypeptides, nucleic acids, other proteins, synthetic polymers, and carbohydrates.

By “diluent” is meant a fluid medium that is miscible with the fluid medium of a sample, or is capable of transferring a reagent, stabilizer, or other chemical species to or removing such agents from a sample. Typically, diluents are liquids. A diluent, for example, contains agents to alter pH (e.g., acids, bases, or buffering agents) or reagents to chemically modify analytes in a sample (e.g., to label an analyte, conjugate a chemical species to an analyte, or cleave a portion of an analyte) or to effect a biological result (e.g., growth media or chemicals that elicit a cellular response or agents that cause cell lysis). A diluent may also contain agents for use in fixing or stabilizing cells, viruses, or molecules. A diluent may also be chemically or biologically inert. A diluent need not dilute sample in the methods and systems of the invention, and an analyte may be concentrated in a diluent by action of an analytical device.

By “immiscible” is meant not completely miscible. For example, air is immiscible in aqueous solutions, notwithstanding the fact that a small proportion of air may be dissolved in an aqueous solution.

By “microfluidic” is meant having one or more dimensions of less than 1 mm. For example, a microfluidic device includes a microfluidic channel having a height, width, or length of less than 1 mm.

By “particle” is meant an object that does not dissolve in a solution on the time scale of an analysis.

By “specifically binding” a type of analyte is meant binding an analyte of that type by a specified mechanism, e.g., antibody-antigen interaction, ligand-receptor interaction, nucleic acid complementarity, protein-protein interaction, charge-charge interaction, and hydrophobic-hydrophobic or hydrophilic-hydrophilic interactions. The strength of the bond is generally enough to prevent detachment by the flow of fluid present when analytes are bound, although individual analytes may occasionally detach under normal operating conditions.

By “specifically retained” is meant retained based on a specific characteristic, e.g., size, shape, deformability, or chemical identity.

Other features and advantages will be apparent from the following description and the claims.

### BRIEF DESCRIPTION OF THE DRAWINGS

FIG. 1a is a schematic diagram of a delivery system including inline dilution.

FIG. 1b is a schematic diagram of a delivery system including an online mixer and online dilution.

FIG. 1c is a schematic diagram of a delivery system including on-chip mixing in a microfluidic device (i.e., chip) and online dilution.

FIG. 2a is a schematic diagram of a delivery system as described in Example 2.

FIG. 2b is a schematic diagram of a delivery system as described in Example 2.

FIG. 2c is a schematic diagram of a sample container having a cone-shaped bottom in order to maximize sample removal.

FIG. 3 is a schematic diagram of a delivery system as described in Example 3.

FIG. 4 is a schematic diagram of a delivery system as described in Example 5.

FIG. 5 is a schematic diagram of a plug for a sample container that provides an inlet and an outlet.

The drawings are not necessarily to scale.

### DETAILED DESCRIPTION OF THE INVENTION

It is often desirable to automate the transfer of a fluid medium containing an analyte, e.g., blood cells, from a sample container to an analytical device. Automated transfer is also beneficial in situations where the analysis requires a relatively constant flow of fluid medium at relatively low flow rates, and avoiding sedimentation of any particles or separation of immiscible fluids is desirable. It may also be desirable to mix a sample with appropriate diluents, e.g., those containing anticoagulants or other reagents, to facilitate subsequent processing and analysis. Automated sample processing is also important for samples that may create hazardous aerosols or be biohazards or susceptible to contamination or degradation. With such samples, processing without a technician needing to open the container is preferable. Furthermore, when a sample is being delivered to an analytical device, especially a microfluidic device, for analysis, methods that enhance wetting of the device in order to avoid entrapping bubbles, which could interfere with the analysis, are desirable. Biological samples are frequently of low volume, and the ability to transfer a high percentage of the sample to an analytical device is desirable, particularly when a low quantity of an analyte from the sample is to be analyzed or detected by the device.

Several embodiments of a system that delivers a fluid medium, e.g., a homogeneous or non-homogeneous mixture of particles, such as blood, to an analytical device, while also providing the ability to mix diluents with the sample, are described below. Each of these embodiments will be described specifically with respect to a blood sample, but the methods and devices are broadly applicable to other fluid media, e.g., solutions, suspensions, or mixtures of particles in a fluid medium. Furthermore, although the following discussion focuses on mixtures of samples and diluents, any two or more fluid media may be combined using the methods and systems of the invention.

### EXAMPLE 1

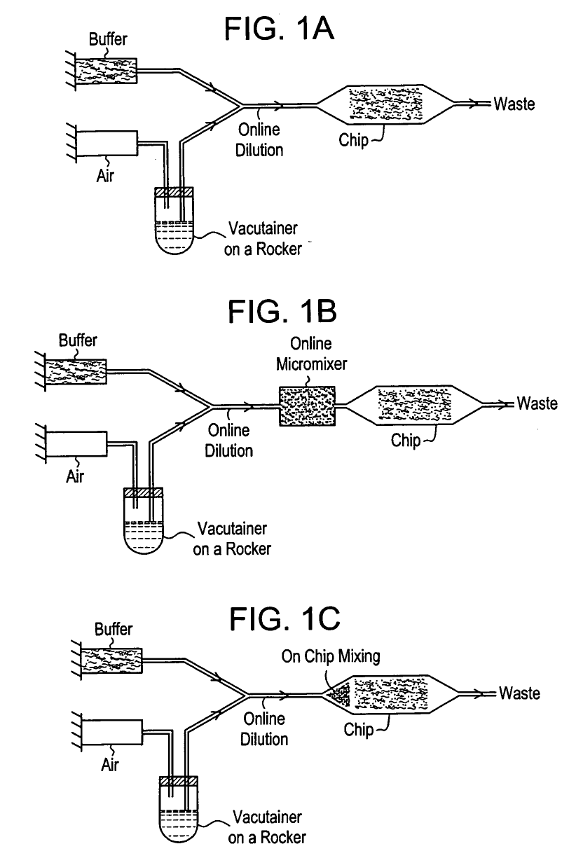

This system is described with reference to FIGS. 1a-1c. The system is based on positive displacement of blood from a sample container with inline dilution, control of sedimentation, and optional enhancement of mixing. A positive displacement pump, e.g., a syringe pump, drives a pressurizing fluid, such as air or immiscible oil, into the sample container through an inlet, e.g., a needle penetrating a septum. This influx of fluid displaces blood through an outlet, e.g., a second needle penetrating the septum (FIG. 1a). In order to enable extraction of the majority of the blood sample from the sample container, the outlet is preferably long enough to reach the bottom of the tube. Sedimentation is prevented by mechanically rocking the container through an angle of slightly less than 180°, such that the tip of the inlet does not contact the blood. This arrangement avoids entrainment of pressurizing fluid in the blood to be delivered to an analytical device. Diluent may be supplied from a reservoir by a second positive displacement pump to provide any desired level of dilution of the blood sample. Because of the low Reynolds-number laminar-flow regime of the sample and diluent, a means to enhance mixing of the streams, by putting energy into the system, may be employed. One method for accomplishing this is through the use of an acoustic transducer or mechanical fluid mixer (FIG. 1b). An alternate approach is to create a zone of higher Reynolds-number flow, in the turbulent regime, e.g., through the use of a microfabricated channel on the front end of a microfluidic device (FIG. 1c). Mixing would be very rapid because of convective transport in this zone, and particle damage can be minimized by keeping the length of the turbulent zone short. Fluids may also be mixed by diffusion.

### EXAMPLE 2

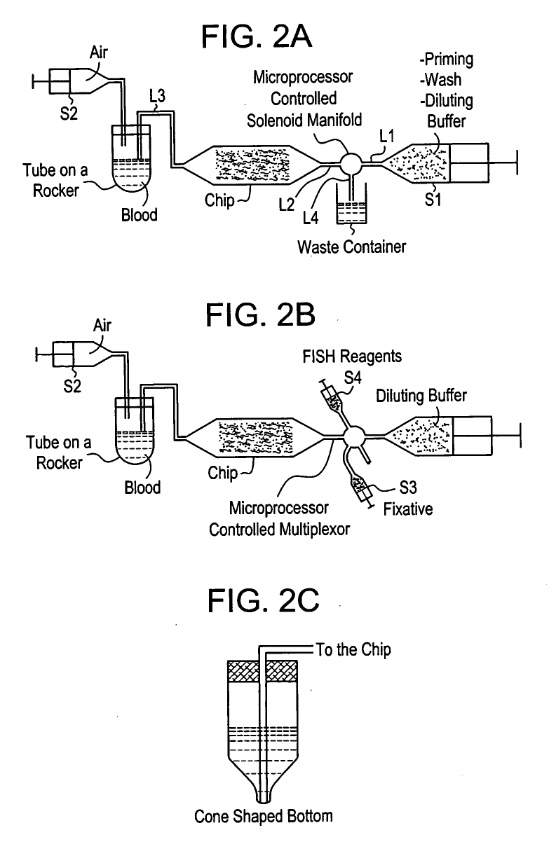

The system is based on the serial fluidic connection of a blood container, an analytical device, and a diluent reservoir. The system makes use of both inlet and outlet connections to the analytical device to enable priming or wetting of the device while diluting the blood sample to any desired volume. FIG. 2a is a schematic representation of the system. The system is operated as follows: a mechanical rocker holds a blood sample in the sample container, diluent from the reservoir is pushed by a positive displacement pump (S1) into the sample container through line L1, a fluidic switch, e.g., a microprocessor controlled solenoid manifold, actuated to block flow to L4, L2, the analytical device, e.g., a microfluidic device, and L3 at a chosen flow rate to enable priming of the device and timely dilution of the blood. The flow rates may range from 0.1-200 ml/hr. Once the blood is diluted to the desired volume, the pumping of S1 is terminated, the diluted blood sample is then pumped by a positive displacement pump (S2) at a desired flow rate through L3, the device, L2, the fluidic switch actuated to block flow to L1, and L4 into a waster container. The above steps can be repeated multiple times until sufficient sample fluid is contacted with the analytical device. In some embodiments, S2 drives a pressurizing fluid, e.g., air, into the sample container and displaces the blood through L3, the device, and out to waste via L4. A portion of the sample or the entire sample may be passed through the analytical device. In any of the embodiments herein, multiple sample containers may be connected to an analytical device via a branched L3 or a plurality of L3 connections. The plurality of sample containers can have independent displacement pumps (S2) or use a joint pump. At the end of the run, the pumping of S2 is terminated. Further processing may then occur. For example, S1 is reengaged to flush diluent through the device and into the sample container, which now serves as a second waste container. In additional embodiments, additional fluid sources may be coupled to the fluidic switch, as shown in FIG. 2b. In these embodiments, S3 may pump reagents into the analytical device, e.g., to fix and prepare captured blood cells for staining with fluorescent probes, and additional pump S4 may be used to introduce fluorescent probes, e.g., FISH reagents, into the device (FIG. 2b). Additional fluid sources or reservoirs can also be coupled to the valve, L1, L2, L3, or L4. Moreover, additional pumps (S5, S6, S7 . . . S100) are also contemplated by the present invention and can be coupled to the valve or other elements of the system. Additional diluent rinses may also be effected through S1 or additional reservoirs attached to the system. In a preferred embodiment, the sample container has a small diameter cone bottom to contain and submerge the tip of L3 in blood at all times with minimal loss of unprocessed sample (FIG. 2c).

### EXAMPLE 3

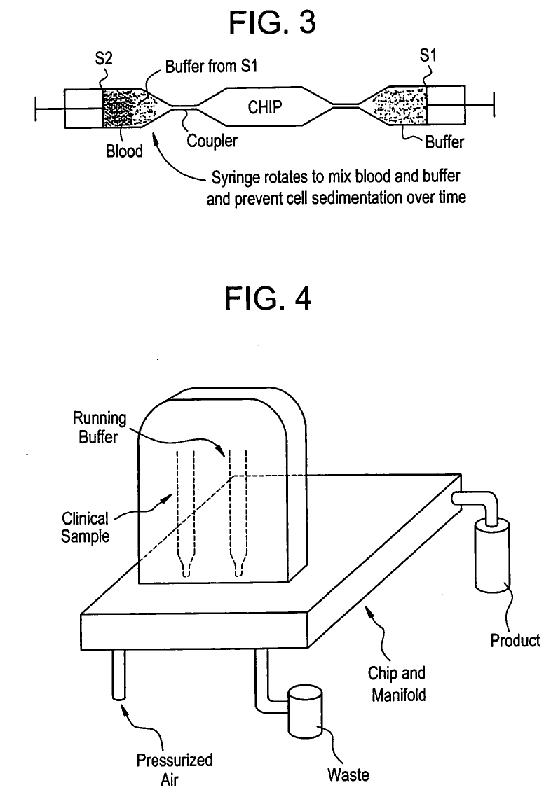

With reference to FIG. 3, another embodiment of the device, which is designated as a “chip,” disposes the blood in a sample container, e.g., a syringe, S2 and the diluent in another container, e.g., a second syringe, S1. S1 is connected to one port of an analytical device, and S2 is connected to another port of the device. Diluent is pumped through the device by displacement, e.g., a combination of push and pull of syringes. The diluent primes the device and dilutes the blood in S2. S2 may be in constant rotation to aid in mixing of the blood and buffer and to prevent cell sedimentation in the container during processing. A coupler may be employed to prevent rotation induced twisting of the fluid line connecting S2 to the device. At least a portion of the diluted blood sample is then passed through the device and into S1.

### EXAMPLE 4

In this embodiment, the system contains two containers in series, a sample container and a diluent reservoir. An amount of blood is pumped by positive displacement from the sample container into the diluent reservoir, both of which are disposed on a mechanical rocker for mixing and sedimentation control. In this embodiment, dilution occurs in a pre-determined volume of buffer in a second tube. A controllable vent may be kept open until the blood sample is displaced into the second tube, after which the vent may be closed to allow subsequent positive displacement pumping to be used to displace the mixed sample (e.g., diluted sample) from the second tube into an analytical device. A frit or filter on the vent outlet would prevent the discharge of any analyte-containing, e.g., cell-containing, aerosols, and any contamination from the outside environment.

### EXAMPLE 5

With reference to FIG. 4, another embodiment of the system is based on positive displacement of blood contained in a sample container comprising an inlet and an outlet, e.g. a 100-ml syringe, and buffer contained in a diluent reservoir comprising an inlet and an outlet, e.g. a 100-ml syringe. The blood sample is optionally pre-diluted or otherwise manipulated before being placed in the sample container. The sample container and diluent reservoir are each fluidically coupled to an analytical device. The inlet of the sample container is disposed within a chamber capable of being pressurized, and optionally the inlet of the diluent reservoir is disposed within the same chamber or another chamber. In FIG. 4, the chamber is formed by a cap placed over a sample container and a diluent reservoir. A positive displacement pump, e.g., a syringe pump, drives an immiscible pressurizing fluid, such as air, into the chamber. This influx of pressurizing fluid displaces blood through the outlet, and also the diluent, if present. The pressure inside the chamber may be controlled manually or by an external computer. In order to enable extraction of the majority of the blood sample from the sample container, pressure is maintained at an appropriate level within the chamber for a duration sufficient to effect partial or substantially complete emptying of this container. The progress of the sample delivery is timed or otherwise monitored by the external computer in order to determine when to stop. The sample container may be in constant rotation or otherwise agitated to prevent cell sedimentation in the container during processing.

### Alternative Embodiments

One skilled in the art may alter the specific components of the systems described in the above-examples to achieve the same purpose. For example, controlling the sedimentation of particles (or otherwise maintaining a homogenous fluid medium), i.e., agitation, may be achieved by any means, including introduction of mechanical or acoustical energy or by circulating the fluid. Examples include mechanical rocking, magnetic stirring, sonication, use of a bubble actuator, or fluid circulating. The frequency and amplitude of sonic waves may be optimized for the particular analyte involved, e.g., living biological cells, to aid in mixing without any deleterious effects on the analyte. For magnetic stirring, a small magnet, preferably poly(tetrafluoroethylene)-coated, could be placed in container requiring mixing, with the container located on a magnetic stir-plate. A relatively low rotational speed such as 1 per second may be employed to avoid damaging the analyte. Furthermore, although separate input and output are described in the above-examples, a spike containing both or a co-axial input and output may be employed. It is also envisioned that a pressure relief device, e.g., a valve, may be incorporated into any container to be pressurized to avoid hazardous release of analyte, e.g., aerosolized blood, or loss of sample, in the event of a blockage of the tubing or flow passage to the analytical device. Any suitable positive displacement pump may be used to transport fluids. Examples include syringe pumps, introduction of a pressurizing fluid, preferably immiscible in the sample, to a container or through the use of a syringe attached to a syringe pump as a sample container, and regulated pressure sources. One advantage of using a regulated pressure source to drive fluids is that the pressure in the system is limited to the regulated source pressure. Multiple, independently controlled positive displacement pumps may be used to provide any desired amount of one or more fluid media to the sample. For example, a pump controlling the displacement of a diluent may provide any desired level of dilution of a blood sample. Fluids may also be transported via gravity feed, negative displacement (e.g., vacuum), gas pressure, or an immiscible fluid, such as mineral oil. Mixers may also be employed when two fluids are introduced into a connector, e.g., a transfer line, when the Reynolds number is low and when diffusional mixing is insufficient. Such mixers may be employed in the connector or at an appropriate point in the analytical device. Such mixers are known in the art. Transfer lines, i.e., fluidic connections, between components of the system may be any material suitable for use with the analytes and fluids employed, e.g., plastics, ceramics, glass, or metals. Connections between components can be made by any suitable, liquid tight connection, as known in the art. In addition, when small sample volumes are employed, connections that have low dead volume are preferable.

For embodiments employing a chamber, any suitable chamber capable of being pressurized may be used. For example, a chamber may be formed by placing a cap over the inlet of the sample container, or over the entire sample container. Alternatively, the sample container may be placed inside the chamber, e.g., through an adjustable opening in the chamber. The chamber may be integrated with the device, entirely separate from the device, or formed by placing a cap in contact with the device. The chamber may also be a channel, e.g., a tube, fitted to an inlet of a fluid containing reservoir and through which a pressurizing fluid may flow. The chamber, once pressurized, may be at any pressure greater than the pressure inside the analytical device. The chamber may or may not form an airtight seal when pressurized. The diluent reservoir may also be placed in the same chamber, or a second chamber capable of being pressurized may be used for the diluent reservoir. When two or more chambers are employed, they may be pressurized together or independently, e.g., to provide different fluid flow rates.

If a diluent reservoir is present, any diluent contained therein need not dilute sample in the methods and systems of the invention.

Sample Containers

In general, any sample container having at least one fluid port (e.g., an outlet) and being suitable to contain the fluid medium of the sample may be employed in the methods and systems described. Such containers may be made of any size, shape, or material. Sample containers may also contain more than one port, e.g., for output and to introduce diluent or a pressurizing fluid (such as air, nitrogen, or a fluid immiscible in the sample on the time scale of pumping). An outlet port may be used to deliver a sample to an analytical device, and an inlet port may be used to introduce a second fluid sample. A single port may also be used for dual purposes, e.g., input of diluent and output of mixed sample (e.g., diluted sample), as described.

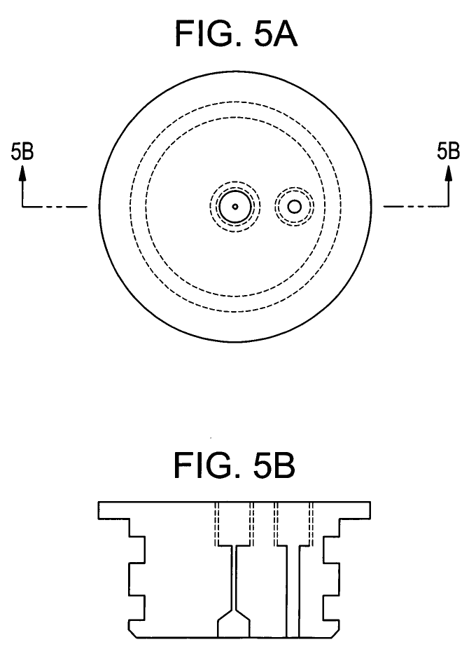

In one embodiment, the sample container is closed with a plug as shown in FIG. 5. This plug contains two ports, an outlet in the center of the plug and an inlet spaced apart from the outlet. The inlet is preferably not located within the depression. When the plug is inserted into a sample container, e.g., a 50 mL tube, the tube is inverted, and the sample contacts the plug by gravity. The outlet is connected to a depression on the top of the plug in contact with the sample. A depression of the plug can be of any shape, e.g., round or angular. The diameter of the depression is, for example, between ⅛ and ½ the diameter of the plug. When a pressurizing fluid, e.g., air, is introduced into the container through the inlet, the resulting pressure buildup forces sample through the outlet, which may be threaded to fit small compression fittings. Other types of fittings could be used in conjunction with corresponding machined details. The depression isolates a small volume of sample being introduced in the outlet at a given point in time and prevents entrainment of the pressurizing fluid into the sample. The design of the plug also reduces the possibility of pressurizing fluid from being introduced into the outlet during mechanical rocking, while also enabling withdrawal of a greater percentage of the fluid in the vessel. Sealing may be provided by a pair of O-rings, e.g., sized to fit typical 50 mL conical tubes. Other tube sizes can be accommodated by appropriately sized plugs and O-rings. Alternative sealing arrangements are also possible. For example, the plug may be fabricated from an elastic material and compression fit in the sample container. This plug is advantageous over the use of two needles, one short needle located near the top of a container and one long needle located at the bottom of the container, because of the difficulty of maintaining the long needle on the centerline of the vessel and the limited volume that can be delivered without uncovering the tip of the long needle during mechanical rocking.

The plugs disclosed herein can be used with any system known in the art which requires delivery of a fluid medium from one container to a location outside the container. The plug is especially useful for partial or substantially complete removal of a fluid sample. For example, the systems and plugs herein can remove more than 95%, 99%, 99.5%, 99.9% or 99.99% of a fluid sample from a sample container. The plug and system herein also allow for an automated high-throughput system for delivery of a solution to an analytical device. In some embodiments, sample flow rate and data obtained from an analytical device are simultaneously processed using a single computing unit.

Analytical Devices

The methods of the invention may be employed in connection with any analytical device. Examples include affinity columns, particle sorters, e.g., fluorescent activated cell sorters, capillary electrophoresis, microscopes, spectrophotometers, sample storage devices, and sample preparation devices. Microfluidic devices are of particular interest in connection with the systems described herein.

Exemplary analytical devices include devices useful for size, shape, or deformability based enrichment of particles, including filters, sieves, and deterministic separation devices, e.g., those described in International Publication Nos. 2004/029221 and 2004/113877, Huang et al. Science 304, 987-990 (2004), U.S. Publication No. 2004/0144651, U.S. Pat. Nos. 5,837,115 and 6,692,952, U.S. Application Nos. 60/703,833 and 60/704,067, and the U.S. application entitled “Devices and Methods for Enrichment and Alteration of Cells and Other Particles” and filed on Sep. 15, 2005; devices useful for affinity capture, e.g., those described in International Publication No. 2004/029221 and U.S. application Ser. No. 11/071,679; devices useful for preferential lysis of cells in a sample, e.g., those described in International Publication No. 2004/029221, U.S. Pat. No. 5,641,628, and U.S. Application No. 60/668,415; and devices useful for arraying cells, e.g., those described in International Publication No. 2004/029221, U.S. Pat. No. 6,692,952, and U.S. application Ser. Nos. 10/778,831 and 11/146,581. Two or more devices may be combined in series, e.g., as described in International Publication No. 2004/029221.

In particular embodiments, the analytical device may be used to isolate various analytes from a mixture, e.g., for collection or further analysis. In one desirable embodiment, rare cells are retained in the device or otherwise enriched compared to other cells, as described, e.g., in International Publication No. 2004/029221. Exemplary rare cells include, depending on the sample, fetal cells, e.g. fetal nucleated red blood cells (fnRBCs), progenitor cells, stem cells (e.g., undifferentiated), foam cells, cancer cells, immune system cells (host or graft), epithelial cells, endothelial cells, connective tissue cells, bacteria, fungi, viruses, and pathogens (e.g., bacterial or protozoa). Such rare cells may be isolated from samples including bodily fluids, e.g., blood, or environmental sources, e.g., pathogens in water samples. Fetal red blood cells may be enriched from maternal peripheral blood, e.g., for the purpose of determining sex and identifying aneuploidies or genetic characteristics, e.g., mutations, in the developing fetus. Cancer cells may also be enriched from peripheral blood for the purpose of diagnosis and monitoring therapeutic progress. Bodily fluids or environmental samples may also be screened for pathogens, e.g., for coliform bacteria, blood borne illnesses such as sepsis, or bacterial or viral meningitis. Rare cells also include cells from one organism present in another organism, e.g., cells from a transplanted organ. An analyte retained in or enriched by the device may, for example, be labeled, e.g., with fluorescent or radioactive probes, subjected to chemical or genetic analysis (such as PCR, RT-PCR, DNA sequencing, mass spectrometry, or fluorescent in situ hybridization), or, if biological, cultured.

Analytical devices may or may not include microfluidic channels, i.e., may or may not be microfluidic devices. The dimensions of the channels of the device into which an analyte is introduced may depend on the size or type of analyte employed. Preferably, a channel in an analytical device has at least one dimension (e.g., height, width, length, or radius) of no greater than 10, 9.5, 9, 8.5, 8, 7.5, 7, 6.5, 6, 5.5, 5, 4.5, 4, 3.5, 3, 2.5, 2, 1.5, or 1 mm. Microfluidic devices employed in the systems and methods described herein preferably have at least one dimension of less than 1, 0.9, 0.8, 0.7, 0.6, 0.5, 0.4, 0.3, 0.2, 0.1, or even 0.05 mm. The dimensions of an analytical device can be determined by one skilled in the art based on the desired application.

Wetting of Devices

In some embodiments, it may be desirable to wet the analytical device prior to use in order to prevent entrapment of, for example, gas bubbles. Any wetting agent, such as those known in the art, may be used for purposes of wetting an analytical device herein. The wetting agents used may be contained in one or more wetting reservoirs and dispensed by one or more of the methods disclosed herein. For example, the wetting agent can be in a reservoir enclosed with a plug of the invention and an independent pressurizing system. Removal of the wetting agent from the reservoir to the analytical device can be actuated by delivering a pressurizing fluid such as a gas to the reservoir through a first inlet to cause the wetting agent to be removed from a first outlet in the reservoir. In devices that rely on the uniform flow of fluid media, such as buffer-diluted blood, supplied by the dispensing systems described herein, it is preferable to avoid uneven wetting of the analytical device, e.g., in microfluidic channels, that can cause uneven flow because of entrapped gas bubbles in unwet regions. Any wetting method or agent can be employed in combination with an analytical device used in the systems described herein. The wetting agents used can be contained in one or more wetting reservoirs and dispensed by one or more of the methods disclosed herein. For example, the wetting agent can be in a reservoir enclosed with a plug of the invention and an independent pressurizing system. Removal of the wetting agent from the reservoir to the analytical device can be actuated by delivering a pressurizing fluid such as a gas to the reservoir through a first inlet to cause the wetting agent to be removed from a first outlet in the reservoir. Methods that address wetting include:

1) Initial flow of buffer containing surfactant: This approach involves using a special buffer tailored to enhance wetting by incorporating a surfactant. This concentration is desirably low enough to avoid damaging the integrity of any analytes.

2) Initial flow of buffer while exposing the device to acoustic vibrations: Acoustic vibration, especially in the ultrasonic regime, can have a beneficial effect in promoting the wetting of surfaces. In this approach, the ultrasonic transducer may be incorporated into the device.

3) Coating portions of the device, e.g., the device lid, with a chemical layer chosen to enhance wetting, e.g., a dried aqueous solution of sugar.

4) Plasma etching of the device: A reactive plasma etch process can reduce the surface tension of aqueous solutions on polymers and other surfaces. For example, improving the wettability of the device lid, e.g., a polymer film, can improve the wettability of the entire device.

5) Assemble the device while submerged under buffer to ensure that the device is substantially wetted and free of gas (e.g., air) bubbles.

Purging the device with carbon dioxide: The purge drives out air, and residual CO₂ is rapidly dissolved into incoming priming buffer because of the high solubility of CO₂ in aqueous solutions. Other gases may be employed in other solvent systems.

### Other Embodiments

All publications, patents, and patent applications mentioned in the above specification are hereby incorporated by reference. Various modifications and variations of the described method and system of the invention will be apparent to those skilled in the art without departing from the scope and spirit of the invention. Although the invention has been described in connection with specific embodiments, it should be understood that the invention as claimed should not be unduly limited to such specific embodiments. Indeed, various modifications of the described modes for carrying out the invention that are obvious to those skilled in the art are intended to be within the scope of the invention.

Other embodiments are in the claims.

What is claimed is:

1. A method for delivering an analyte to an analytical device, said method comprising the steps of:
(a) providing:
(i) a sample container comprising a first inlet, a first outlet coupled to said analytical device, and a first liquid medium comprising said analyte;
(ii) a chamber capable of being pressurized; and
(iii) said analytical device;
(b) disposing said first inlet in said chamber; and
(c) pumping a pressurizing fluid immiscible with said first liquid medium into said chamber, thereby causing at least a portion of said first liquid medium to flow from said sample container through said first outlet into said analytical device.

2. The method of claim 1, wherein step (a) further comprises providing a diluent reservoir comprising a second inlet, a second outlet coupled to said analytical device, and a second liquid medium comprising a diluent.

3. The method of claim 2, wherein step (b) further comprises disposing said second inlet in said chamber of (ii) or in another chamber capable of being pressurized, and wherein step (c) further comprises causing at least a portion of said second liquid medium to flow through said second outlet into said analytical device.

4. The method of claim 1, wherein, during step (c), said first liquid medium comprising said analyte is pumped through said analytical device.

5. The method of claim 1, wherein step (c) further comprises agitating said sample container to substantially maintain homogeneity.

6. The method of claim 1, wherein said first liquid medium comprises a biological fluid or portion thereof.

7. The method of claim 6, wherein said biological fluid comprises blood, lymph, semen, urine, cerebrospinal fluid, saliva, sputum, or a cell suspension.

8. The method of claim 1, wherein said analyte comprises a particle.

9. The method of claim 8, wherein step (c) further comprises agitating said sample container to substantially maintain homogeneity, and wherein said agitating substantially reduces sedimentation of said particle.

10. The method of claim 8, wherein said particle is a cell.

11. The method of claim 1, wherein, when said analyte is delivered to said analytical device, said analyte is analyzed.

12. The method of claim 11, wherein said analyte is analyzed by contacting said analyte with a labeling moiety.

13. The method of claim 11, wherein said analyte comprises a cell, and said cell is analyzed by PCR, RT-PCR, DNA sequencing, mass spectrometry, or in situ hybridization.

14. The method of claim 1, wherein, when said analyte is delivered to said analytical device, a sample enriched in said analyte is produced.

15. The method of claim 14, wherein said analytical device comprises capture moieties capable of selectively binding said portion of said analyte.

16. The method of claim 14, wherein said analytical device comprises a size, shape, or deformability based separation medium.

17. The method of claim 14, wherein said analytical device comprises a magnetic based separation medium.

18. The method of claim 1, wherein said analytical device is a microfluidic device.

19. The method of claim 1, wherein said pressurizing fluid comprises a gas.

20. The method of claim 19, wherein said gas comprises air.

21. A delivery system comprising:
(i) an analytical device;
(ii) a sample container comprising a first inlet and a first outlet, wherein said first outlet is coupled to said analytical device; and
(iii) a chamber that is fluidically connected to said first inlet and is capable of being pressurized.

22. The delivery system of claim 21, wherein said chamber is integrated into said device.

23. The delivery system of claim 21, wherein said chamber comprises a cap enclosing said sample container.

24. The delivery system of claim 21, further comprising a diluent reservoir comprising a second inlet and a second outlet, wherein said second outlet is coupled to said analytical device.

25. The delivery system of claim 21, wherein said second inlet is fluidically connected to said chamber.

26. The delivery system of claim 21, further comprising an agitator that agitates said sample container to substantially maintain homogeneity.

27. The delivery system of claim 21, wherein said analytical device comprises capture moieties capable of selectively binding said portion of said analyte.

28. The delivery system of claim 21, wherein said analytical device comprises a size, shape, or deformability based separation medium.

29. The delivery system of claim 21, wherein said analytical device comprises a magnetic based separation medium.

30. The delivery system of claim 21, wherein said analytical device is a microfluidic device.
